(19) United States
(12) Patent Application Publication
(10) Pub. No.: US 2003/0221803 A1
(43) Pub. Date: Dec. 4, 2003

(54) Roll-up door with foam core

(76) Inventor: Kent H. Forsland, River Falls, WI (US)

Correspondence Address: MERCHANT & GOULD PC, P.O. BOX 2903, MINNEAPOLIS, MN, 55402-0903, US

(21) Appl. No.: 10/240,888

(22) PCT Filed: Apr. 6, 2001
(86) PCT No.: PCT/US01/11337

(51) Int. Cl. E06B 3/48

(52) U.S. Cl. 160/229.1

(57) ABSTRACT

A roll-up door having one or more sections. Each section includes a foam plastic core between two opposed first and second sheet members. The first and second sheet members are generally similar in overall size, but can be fabricated from different materials. The core is housed between the sheet members and typically is fastened directly to the sheet members. The sections typically also include one or more border members around the periphery of the core. Adjacent panel sections are pivotally hinged. The border members located along the opposed mating portions of adjacent panel sections are stepped, thereby allowing the door to be raised or lowered. One or more panel sections may contain openings and securing means for one or more window assemblies.

This application is being filed as a PCT International Patent Application in the name of Kent A. FORSLAND, a U.S. citizen and resident, on Apr. 6, 2001, designating all countries.

### FIELD OF THE INVENTION

The present invention generally relates to doors used to selectively open and close openings in structures. More specifically, the present invention relates to doors used with buildings having doorways located in a vertical position to close the doorway and a horizontal position to open the doorway.

### BACKGROUND OF THE INVENTION

Doorways in antiquated garages are closed with swinging garage doors attached to upright supports with hinges. These doors must be moved outwardly to open the doorway. The swinging doors require ground and head clearances to allow the doors to open and close.

In order to obviate the clearance requirements of the swinging doors, lateral roll doors were developed. The lateral roll doors have a number of vertical sections hinged together in side-by-side relation. The doors are supported on right angle tracks for movement along the tracks between a closed position and an open position. The tracks are mounted on headers above the doorways and also include side supports extending inwardly to the part of the garage where vehicles are typically housed. This typical arrangement of lateral roll doors makes it difficult to access and egress the garage when a side of the vehicles is located adjacent the doors in the open position.

Roll-up overhead doors were developed to reduce the access and egress problems. Typically, roll-up overhead doors have horizontal sections hinged together between sections. Rollers mounted on the sections engage side tracks having vertical and horizontal sections to locate the door in a vertical closed position and an overhead horizontal position. An example of a roll-up garage door having hinged sections is shown in U.S. Pat. No. 5,168,915. These roll-up doors are heavy and, in some cases, have been usually not efficient at keeping the elements out of the interior of the garage. Improvements are desired.

### SUMMARY OF THE INVENTION

The invention of the present application relates to a lightweight, strong, and economical overhead door having a plurality of transverse sections for closing a doorway in a structure, such as a garage. Each section comprises a one-piece, sturdy rigid structure that has a high strength against bending and twisting. Adjacent sections are connected with hinges to allow the door to articulate from a vertical position to a horizontal position as it moves along side tracks supporting the door adjacent a doorway. Preferably, each section is a rigid, laminated panel having a foam plastic core bonded to an inside sheet member and an exterior sheet member. Typically, the inside sheet member comprises plywood sheet bonded with an adhesive to one side of the core. Typically, the exterior sheet member comprises an exterior siding, for example, cedar siding, bonded with an adhesive to the opposite side of the foam plastic core. Border members located between the peripheral edges of the sheet members surround the foam plastic core. One or more sections may include a window assembly. The window assembly typically includes means for framing a window pane.

### BRIEF DESCRIPTION OF THE DRAWINGS

FIG. 1 is a front elevational view of an example embodiment of a roll-up door;

FIG. 2 is a side elevational view of the door of FIG. 1;

FIG. 3 is a rear elevational view of the door of FIG. 1;

FIG. 4 is a top plan view of FIG. 3;

FIG. 5 is a bottom plan view of FIG. 3;

FIG. 6 is an enlarged sectional view taken along line 6-6 of FIG. 1;

FIG. 7 is an enlarged sectional view taken along line 7-7 of FIG. 1;

FIG. 8 is an enlarged sectional view taken along line 8-8 of FIG. 1;

FIG. 9 is an enlarged foreshortened sectional view taken along the line 9-9 of FIG. 1;

FIG. 10 is a front elevational view of a second example embodiment of a roll-up door;

FIG. 11 is a side elevational view of the door of FIG. 10;

FIG. 12 is an enlarged sectional view taken along line 12-12 of FIG. 10;

FIG. 13 is a rear elevational view of the door of FIG. 10;

FIG. 14 is a top plan view of FIG. 12;

FIG. 15 is a bottom plan view of FIG. 12;

FIG. 16 is a front elevational view of a third example embodiment of a roll-up door;

FIG. 17 is a side elevational view of FIG. 16;

FIG. 18 is a rear elevational view of FIG. 16;

FIG. 19 is a top plan view of FIG. 18;

FIG. 20 is a bottom plan view of FIG. 18;

FIG. 21 is an enlarged front plan view of the top section of the door of FIG. 16 showing a window assembly; and

FIG. 22 is an enlarged foreshortened sectional view taken along line 22-22 of FIG. 21.

### DESCRIPTION OF THE PREFERRED EMBODIMENTS

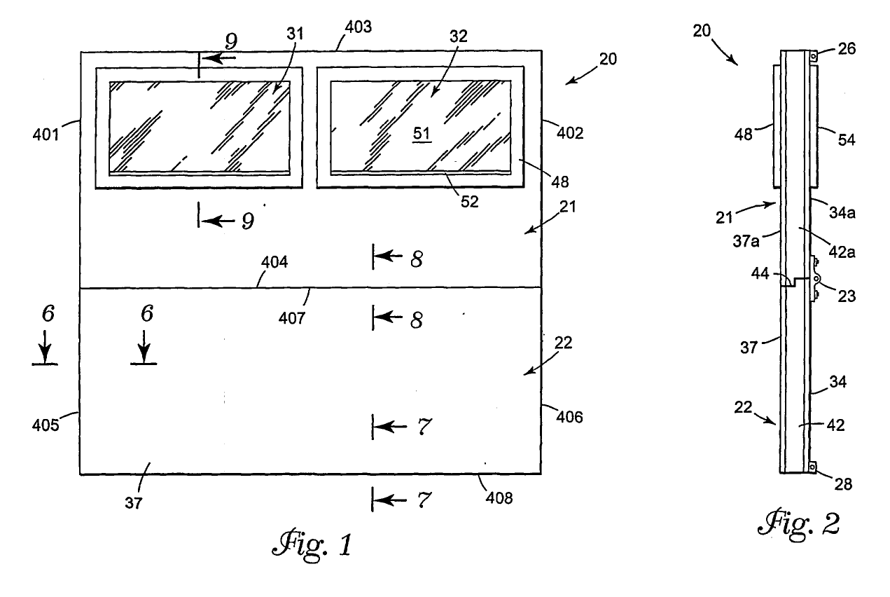

One example embodiment of a roll-up door 20 is shown in FIGS. 1-5. Door 20 includes an upper section 21 and a lower section 22 pivotally coupled using one or more hinges 23, 24 and 25. One or more brackets 26, 27 are secured to opposite upper corners of the portion of section 21 located inside the garage when door 20 is in the closed position. Support brackets 28, 29 are mounted on opposed corners of inside portion of section 22. Rollers (not shown) mounted on hinges 23 and 25 and brackets 26 and 29 movably support door 20 on tracks that guide door 20 between open and closed positions.

In the example embodiment shown, upper section 21 is a one-piece laminated panel further including one or more window assemblies 31, 32. However, there are many alternative window assemblies can be used with section 21. For example, a single window assembly or multiple window assemblies may be incorporated in section 21. The size and arrangement of the window assemblies can vary to fit the length and height of section 21. In another example embodiment, upper section 21 is a solid continuous panel without window assemblies.

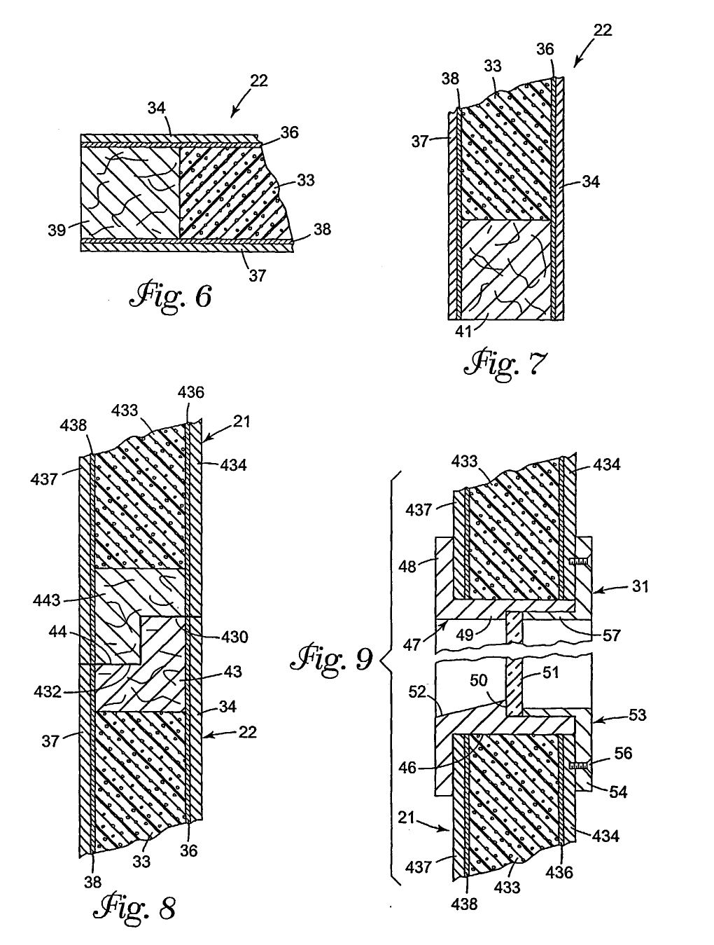

One example embodiment of paneling of section 22 is shown in FIGS. 6 to 8. Section 22 includes a flat internal core 33. Preferably, core 33 is fabricated from expanded or foamed plastic. Preferably, core 33 is a continuous body of rigid polystyrene or rigid expanded polyurethane. However, many other types of foamed, closed-cell plastic can be used to fabricate core 33. In the example embodiment shown, a plywood sheet member 34 is coupled with a layer of adhesive 36 to a first surface 300 of core 33, preferably using an adhesive 36. Alternatively, other coupling methods can be used, depending on the overall appearance desired for door 20. Member 34 may be a 0.25 inch plywood sheet having a finished outer surface 340 that is generally planar. An outer sheet member 37 typically is coupled with an adhesive 38 to a second surface 302 of core 33. One example of outer sheet member 37 is 0.375 inch, 3-ply siding. In another example, sheet member 37 is 0.375 inch medium density overlay. As shown in FIGS. 6 and 7, one or more linear border members 39, 41 are located between the peripheral edge portions of sheet members 34 and 37. In the example embodiment shown, border members 29 and 41 are coupled to sheet members 34 and 37 with adhesive 36, 38. Upper section 21 further includes first edge 401, a second edge 401, a third edge 403 and a fourth edge 404. Generally, sheet members 34, 37 have edges located coextensive with the corresponding edge of section 21.

Referring to FIG. 8, section 22 includes a stepped border member 43 having a first surface 430 and a second surface 432. First surface 430 of border member 43 typically is coupled to sheet member 34 using adhesive 36. Second surface 432 of border member 43 also typically is coupled to sheet member 37 using adhesive 38. Border members 39, 41, 43 surround core 33 and engage flat outer peripheral surfaces of core 33. In the example embodiment shown, border members 39, 40 and 41 are coextensive with the outer edges of sheet members 34 and 27. Lower section 22 further includes a first edge 405, a second edge 406, a third edge 407 and a fourth edge 408. Generally, sheet members 34, 37 have edges located coextensive with the corresponding edge on the section 22.

One method of fabricating section 22 includes arranging core 33, sheet members 34, 37, border members 39, 41, 43 and adhesive 36, 38 in their preferred positions and subjecting the entire assembly to pressure. This method provides for sheet members 34, 37 and border members 39, 41, 43 to be coupled to core 33. One advantage of the described structure is that section 22 is a strong and rigid and relatively light weight structure that has substantial strength against bending and twisting. Another advantage is that reinforcing webs and ribs are not required to inhibit horizontal and vertical bending of the section 22, thus reducing manufacturing cost as well as reducing the labor and materials required to fabricate door 20. Another advantages is that material used for core 33 provides door 20 with sound and thermal insulation.

Upper section 21 has essentially the same laminated panel structure as lower section 22. Parts of the panel of section 21 that correspond with the parts of the panel of section 22 have the same reference numbers with the leading digit 4. The bottom border member 443, as shown in FIG. 8, includes a reverse or downward facing step border member 44 is located adjacent to and is shaped complimentary to the step of border member 43. When door 20 is in the closed or upright position, step surfaces of border members 43 and 443 contact each other, thereby inhibiting air, water, snow and dirt from flowing through door 20.

Referring to FIGS. 1 and 9, window assembly 31 fits in a rectangular hole 46 cut into the panel of section 21. Window assembly 32 is located in similar rectangular hole in section 21. Window assembly 31 includes a first-frame 47 having an outside flange 48 coupled to sheet member 237. The flange 48 is joined to a rectangular body 49 having an inwardly directed shoulder 50. A vertical transparent pane 51, for example glass or plastic, fits in body 49 and engages shoulder 50. A lower surface 52 of body 49 slopes downwardly and outwardly from pane 51 to allow water to drain away from pane 51. A second frame 53 retains pane 51 on body 49. Frame 53 has an outwardly directed flange 54 secured with one or more fasteners 56, for example, bolts, to sheet member 434. Flange 54 is joined to a rectangular body 57 that telescopes into body 49 and contacts pane 51. Second frame 53 can be removed from the first frame 47 if it is necessary replace broken pane 51. Window assembly 32 has substantially the same structure as window assembly 31.

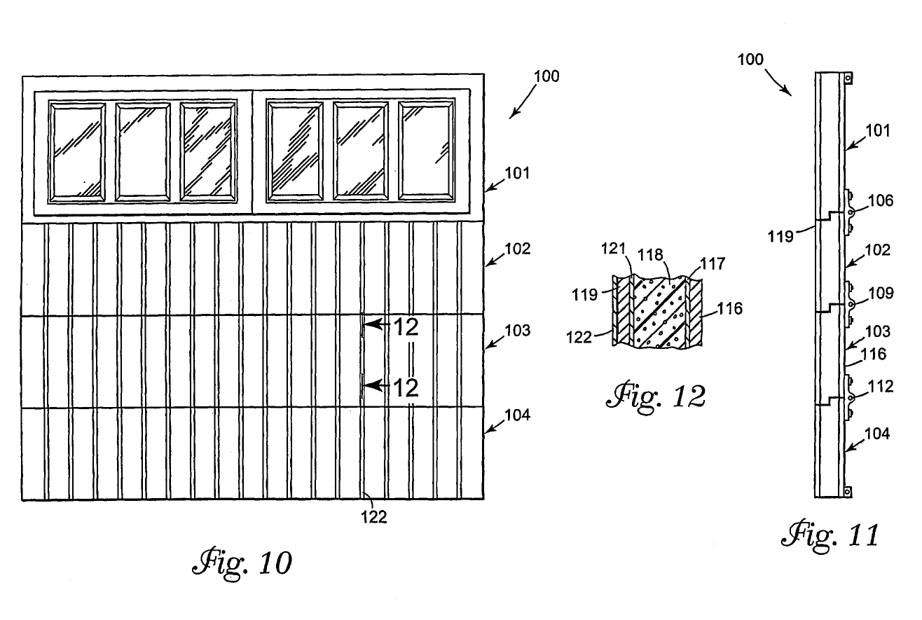

Another example embodiment of a roll-up door 100 is shown in FIGS. 10 to 15. Door 100 includes four rectangular sections 101, 102, 103 and 104. Adjacent sections are pivotally connected with hinges 106-114, as shown in FIGS. 11 and 12. Section 101-104 each include rigid panel construction, as shown in FIGS. 6 through 9. A cross section of the panel of section 103, shown in FIG. 12, includes a plywood sheet member 116 secured with an adhesive 117 layered to an core 118. Preferably, core 118 is fabricated from an expanded plastic, for example Styrofoam or expanded polyurethane.

Referring to FIGS. 10 and 12, outside sheet member 119 can be fabricated from many different materials, depending on the appearance desired for door 100. In the embodiment shown, the appearance could be accomplished by using, for example, grooved cedar siding. Sheet member 119 is coupled to core 118 with layer of an adhesive 121. An outside surface 419 of sheet member 119 includes a vertical groove 122. In the embodiment shown, sheet member 119 includes a plurality of horizontally spaced vertical grooves 122, as shown in FIG. 10. Sections 102 and 104 include corresponding vertical grooves 122 that are vertically aligned with the grooves in sheet member 119. The panels of sections 102 and 104 have the same structure as section 103 as shown in FIG. 12. An advantage of this example embodiment is sections 102, 103 and 104 are flat, strong, sturdy and light weight structures.

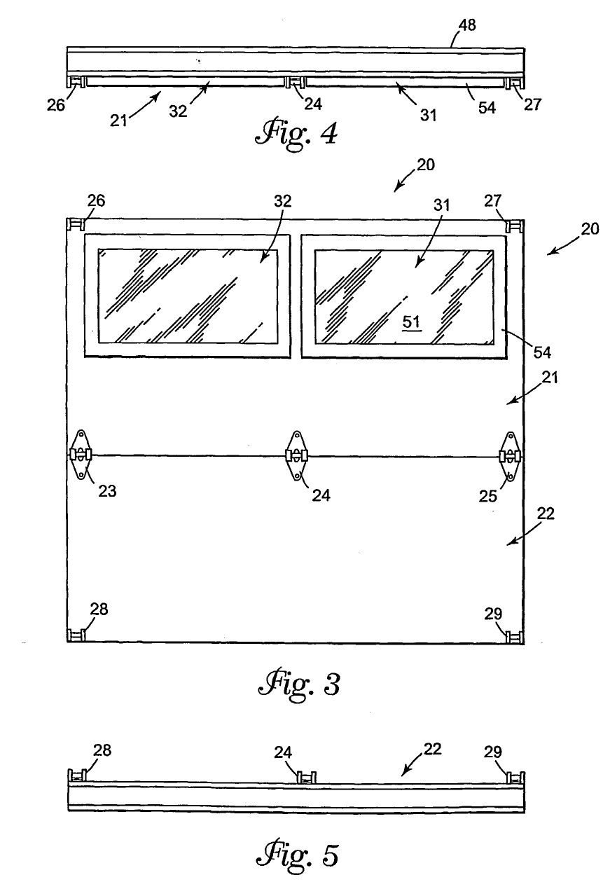

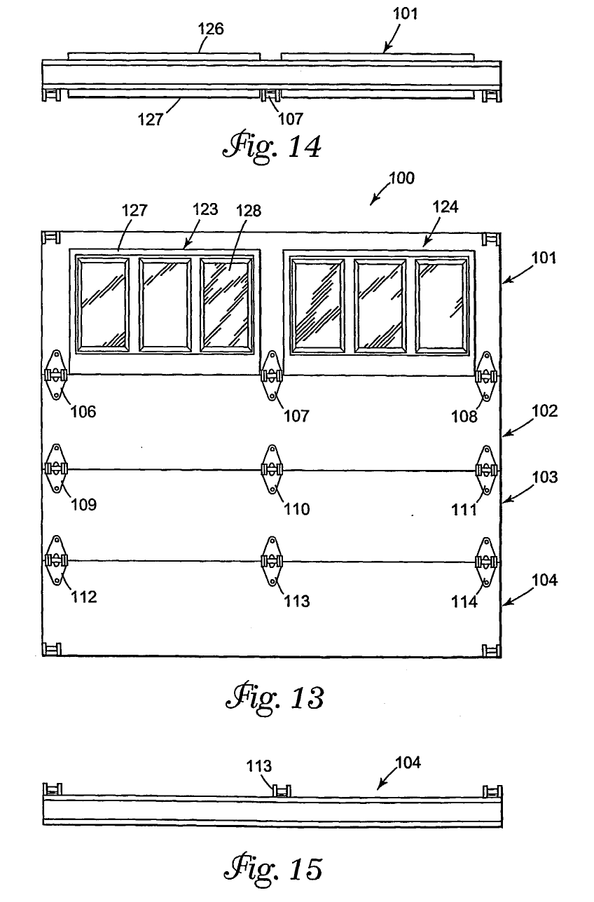

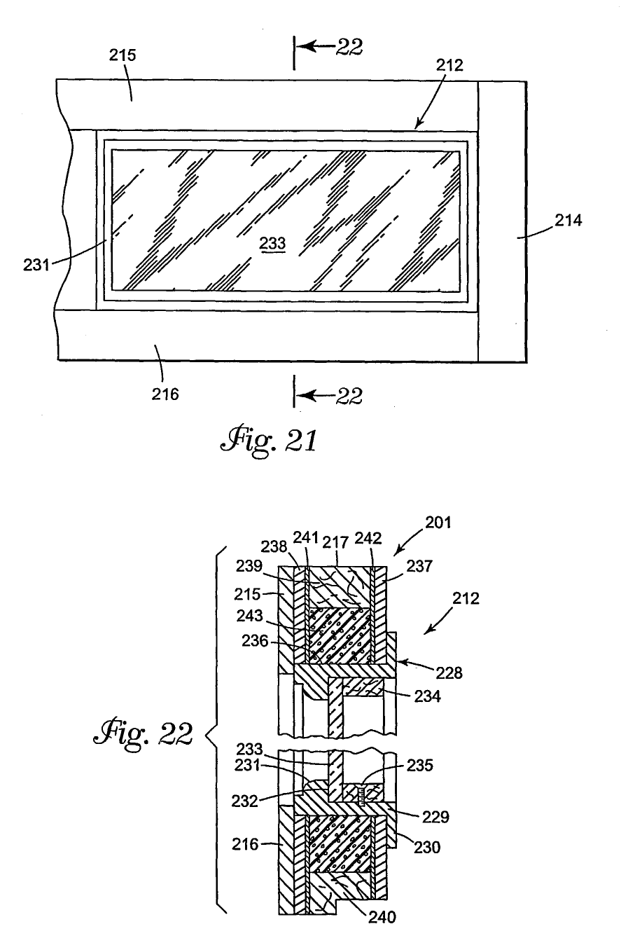

Referring to FIGS. 10 and 13, upper section 101 has a pair of window assemblies 123 and 124. In the example embodiment shown, window assembly 123, 124 has three glass panes. The number of window assemblies and glass panes in each window assembly can vary, depending on the appearance desired for door 100. Each window assembly can have a single glass pane as shown in door 20 in FIGS. 1 and 3. Window assemblies 123 and 124 have frames 126 and 127 and glass pane 128 structures shown in FIG. 9. The window assembly shown in FIGS. 21 and 22 can be mounted on upper section 101.

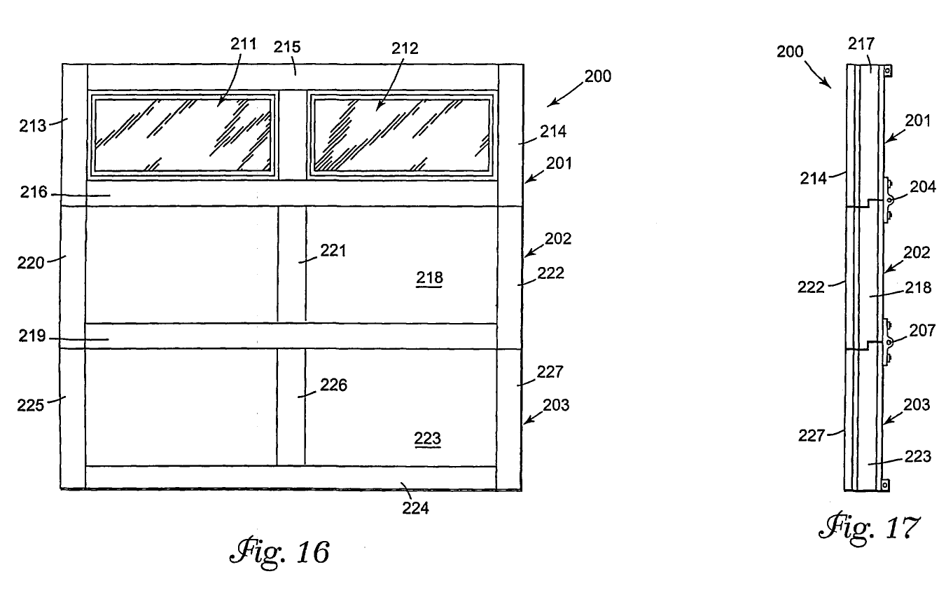

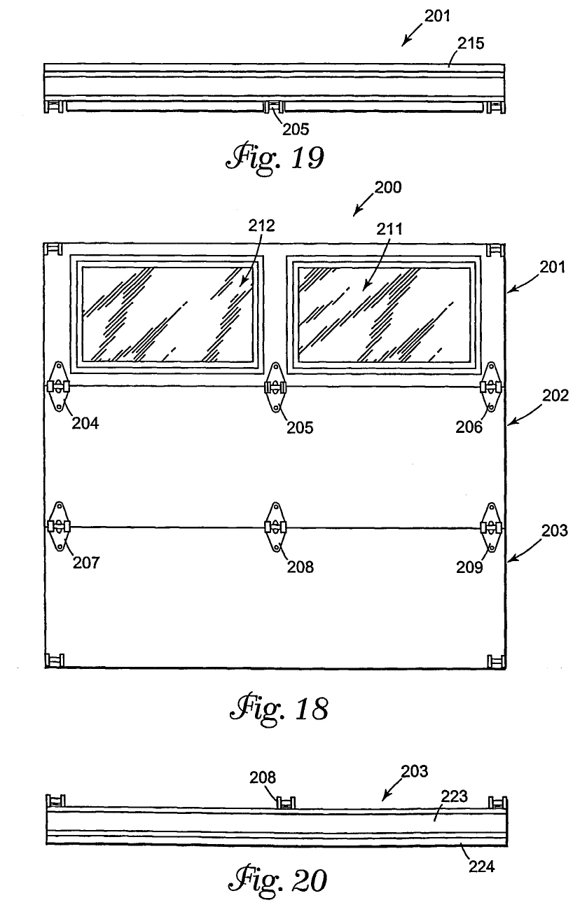

Referring to FIGS. 16 to 22, is shown a second example embodiment of a door 200. Door 200 includes the rigid panels shown in FIGS. 6 to 8 in rectangular door sections 201, 202 and 203. As seen in FIGS. 18 and 19, adjacent section 201 and 202 and 202 and 203 are pivotally connected with hinges 204, 205, 206, 207, 208 and 209.

Upper section 201 has a pair of window assemblies 211 and 212. Trim members 213, 214, 215 and 216 secured to the front of flat panel 217 surrounding window assemblies 211 and 212. Upper section 201 can have a single window assembly or more that two window assemblies, depending on the appearance desired for door 200.

Middle section 202 includes a flat panel 218. Horizontal and vertical trim members 219, 220, 221 and 222 are secured to the front of panel 218. Lower section 203 includes a flat panel 223. A bottom trim member 224 is attached to the bottom of the front of panel 223. Vertical trim members 225, 226 and 227 are secured to the sides and middle of the front of panel 223. Panels 217, 218 and 223 are fabricated as shown in FIGS. 6 to 8, as flat, strong laminated structures having rigid sheet members secured to a foam plastic core.

Window assembly 212, shown in FIGS. 21 and 22 includes a rectangular frame 228 located in a rectangular opening 236 in panel 217. Frame 228 includes a rectangular body 229 that fits in opening 236 and engages flat portions of panel 217 surrounding opening 236. The inside end of body 229 is joined to an outwardly directed flat flange 230 located in engagement with the inside sheet member of panel 217. Adhesives or other fasteners (not shown) secure flange 230 to panel 217. Body 229 has an inwardly projected rib 231 having a shoulder 232. A flat glass pane 233 engages shoulder 232. Rib 231 has a convex outer surface to direct water and snow away from glass pane 233. A rectangular stop member 234 telescoped into body 229 engages glass pane 233 to firmly hold pane 233 on shoulder 232. One or more fasteners 235, such as a screw, secure member 234 to frame 229. Stop member 234 can be removed from frame 229 to allow a broken glass pane to be removed and replaced with a new glass pane. Other transparent sheet members, such as plastic, can be used in the window assembly in lieu of glass pane 233. Window assembly 211 typically has the same structure as window assembly 212.

Referring to FIG. 22, panel 217 may comprise a rigid plywood inner sheet member 237 and a rigid exterior sheet member or siding 238. Panel 217 may also include an upper border member 239 and a lower border member 240. Sheet members 237, 238 and border members 239, 240 typically are secured to core 243 with layers of adhesive such as 241 and 242. In this construction, panel 217 is a rigid, strong and sturdy structure that provides the support for window assemblies 211 and 212. One advantage of the present embodiment is that sheet members 237 and 238 bonded to core 243 and border members 239 and 240 provide a panel with high strengths against bending, buckling and twisting.

While there has been shown and described several embodiments of the roll-up doors of the invention, it is understood that changes and modifications in structure, material, arrangement or structures and materials may be made by those skilled in the art without departing from the invention.

1. A door comprising:
a first section having a first core and a first and a second sheet member, the first sheet member including a first, a second, a third and a fourth edge, and the second sheet member including a fifth, a sixth, a seventh, and an eighth edge wherein the first and fifth edges are coextensive, and the second and sixth edges are coextensive, and end first and second edges are opposed on the first section, wherein the core is secured between the first and second sheet members, the first section further including:
a first border member secured between the first and second sheet members adjacent to a first surface of the first core, wherein a ninth edge of the first border member is coextensive with the first edge of the first sheet member and the fifth edge of the second sheet member;
a second border member secured between the first and second sheet members adjacent to a second surface of the first core, wherein a tenth edge of the second border member is coextensive with the second edge of the first sheet member and the sixth edge of the second sheet member;
a third border member including a first step, the third border member being secured between the first and second sheet members and being adjacent to a third surface of the first core, wherein a first stepped edge of the third border member is coextensive with the third edge of the first sheet member and a second stepped edge of the third border member is coextensive with the seventh edge of the second sheet member;
a second section having a second core and a third and a fourth sheet member, the third sheet member including a twelfth, a thirteenth, a fourteenth and a fifteenth edge, and the fourth sheet member including a sixteenth, a seventeenth, an eighteenth, and a nineteenth edge wherein the twelfth and sixteenth edges are coextensive, and the thirteenth and seventh edges are coextensive, and the twelfth and thirteenth edges are opposed on the second section, wherein the second core is secured between the third and fourth sheet members, the second section further including:
a fourth border member secured between the third and fourth sheet members adjacent to a fourth surface of the second core, wherein a twentieth edge of the fourth border member is coextensive with the twelfth edge of the third sheet member and the sixteenth edge of the fourth sheet member;
a fifth border member secured between the third and fourth sheet members adjacent to a fourth surface of the second core, wherein a twenty-first edge of the fifth border member is coextensive with the thirteenth edge of the third sheet member and the seventeenth edge of the fourth sheet member;
a sixth border member including a second step, the sixth border member being secured between the third and fourth sheet members adjacent to a sixth surface of the core, wherein a third stepped edge of the sixth border member is coextensive with the fourteenth edge of the third sheet member and a fourth stepped edge of the sixth border member is coextensive with the eighteenth edge of the fourth sheet member; and
a hinge pivotally connecting the first and second sections, the hinge further having a first attachment portion and a second attachment portion, the first attachment portion being attached to the first section adjacent the seventh edge of the second sheet member and the second attachment portion being attached to the second section adjacent the eighteenth edge of the fourth sheet member, wherein the first and second steps are opposably mated when the door sections are aligned.

2. The door according to claim 1 wherein the first section includes one or more windows.

3. The door according to claim 1 wherein the first and second cores are a foamed plastic.

4. The door according to claim 3 wherein the foamed plastic is Styrofoam foamed plastic.

5. The door according to claim 1, wherein the first section further includes:
a portion defining a rectangular opening having an upper and a lower surface;
a body fastened to the second sheet, adjacent the upper surface and a first frame located between the upper surface and the body, the first frame having an ascending first flange;
a second frame fastened to the second sheet, adjacent the lower surface and a shoulder located between the lower surface and the second frame, the shoulder including a sloped surface; and
a pane located in the opening secured by the first and second frames.

6. A door according to claim 1, wherein the first section further includes:
an opening including an upper and a lower surface;
a body fastened to the second sheet member, the body further including a first rib and a first shoulder, the body being located on the lower surface of the opening;
a frame fastened to the second sheet member, the body further including a second rib and a second shoulder, the frame being located on the lower surface of the opening;
a pane including an upper edge and a lower edge;
the lower edge of the pane being secured between the first rib and a first stop, the first stop being secured to the body opposite the first rib; and
the upper edge of the pane being secured between the second rib and a second stop, the second stop being secured to the frame opposite the second rib.

7. The door according to claim 5 wherein the pane is made from glass.

8. The door according to claim 6 wherein the pane is made from transparent plastic.

9. The door according to claim 6, wherein a trim panel frames the opening in the first section, the one or more trim panels being planer wither the first sheet.

10. A light weight, strong, and economical overhead door having a plurality of transverse sections for closing a doorway in a structure, such as a garage, as the door moves along side tracks which support the door adjacent the doorway, the overhead door comprising:
adjacent sections coupled with hinges to allow the door to articulate from a vertical position to a horizontal position as door moves along side tracks;
each section comprising:
an interior sheet member
an exterior sheet member; and
a foam plastic core coupled between the interior and exterior sheet members;
wherein each section comprises a light-weight, one-piece, sturdy rigid structure that has high strength against bending and twisting, thereby forming a strong, light-weight door.

11. The door according to claim 10 wherein the interior sheet member is a plywood sheet bonded and the interior sheet member is bonded to one side of the foam plastic core using an adhesive.

12. The door according to claim 11, wherein the exterior sheet member is exterior siding, the exterior sheet member bonded with an adhesive to a second side of the foam plastic core, wherein the second side is opposite the first side.

13. The door according to claim 12, wherein the exterior siding is cedar siding.

14. The door according to claim 10 further including border members located between the peripheral edges of the sheet members surrounding the foam plastic core.
